(19) United States
(12) Patent Application Publication
(10) Pub. No.: US 2003/0188265 A1
(43) Pub. Date: Oct. 2, 2003

(54) Structured document processing device and recording medium recording structured document processing program

(75) Inventor: Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/391,914

(22) Filed: Mar. 19, 2003

(30) Foreign Application Priority Data
Apr. 2, 2002 (JP) 2002-099651
Apr. 24, 2002 (JP) 2002-122540

(51) Int. Cl. G06F 15/00

(52) U.S. Cl. 715/513

(57) ABSTRACT

A structured document processing device including a structured document forming unit which forms a structured document including binary data or a link to the binary data a processing information forming unit which forms text data in the structured documents. The text data indicates attribute information that designates a processing operation for the binary data.

### FIELD OF THE INVENTION

The present invention relates to a device which processes a structured document, and a recording medium which records a program for processing the structured document.

### DESCRIPTION OF THE RELATED ART

Text data and binary data are generally handled by a computer. However, there are cases when the binary data is described as text data by using the Multipurpose Internet Mail Extensions (MIME) Base 64 or the like. In this specification, for convenience, the binary data that is described as the text data by using the MIME Base 64 or the like will be referred to as “character data”, and will be distinguished from the original text data. In addition, a conversion from the binary data into the character data by the MIME Base 64 or the like will be referred to as “binary-character conversion” (or simply “character conversion”). The conversion from the character data into the binary data will be referred to as “character-binary conversion” (or simply “binary conversion”).

There is a proposal to include the binary data such as the character converted image data in the structured document as character data. There is also a proposal to have the binary data as a separate file and to have a link to the binary data in the structured document. However, since such structured documents are not for designating a processing operation to binary data, the processing operation of binary data cannot be carried out automatically.

An advantage of the present invention is to define a processing operation of binary data relating to a structured document by using the structured document itself. In addition, an advantage of the present invention is to determine a processing operation for character-converted binary data to the structured document including the character-converted binary data in accordance with the structured document itself.

Another advantage of the present invention is to determine an output form of the character-converted binary data in accordance with the structured document itself. Another advantage of the present invention is to provide a specific method for determining the processing operation. Another advantage of the present invention is to determine a type of processing operation by using the binary data itself.

### SUMMARY OF THE INVENTION

A structured document processing device of the present invention is a device for forming the structured document that includes binary data or a link to the binary data. The structured document processing device includes a function for providing attribute information that designates a processing operation for the binary data in the text data of the structured document.

In addition, the structured document processing device includes an extracting unit and a processing unit. The extracting unit extracts the attribute information that designates a processing operation for the binary data in the text data of the structured document for the structured document that includes the binary data or a link to the binary data. The processing unit executes a processing operation designated in accordance with the attribute information.

Furthermore, the structured document processing device includes an extracting unit and a processing unit. The extracting unit extracts information for determining a processing operation for the binary data that is character-converted from the structured document for the structured document that includes the text data and the character-converted binary data. Then, the extracting unit determines a type of processing operation. The processing unit executes the processing operation of the determined type.

### BRIEF DESCRIPTION OF THE DRAWINGS

FIG. 1 is a block diagram showing a processing environment of the structured document according to a first embodiment of the present invention.

FIG. 2 is a block diagram of a structured document processing device according to the first embodiment.

FIG. 3 is a view showing a configuration of a processing program of the structured document according to the first embodiment.

FIG. 4 is a view showing a structure of the data of the structured document according to the first embodiment.

FIG. 5 is a view showing an example of the structured document according to the first embodiment.

FIG. 6 is a block diagram showing an environment where a structured document processing device of a second embodiment is used.

FIG. 7 is a block diagram showing the structured document processing device according to the second embodiment.

FIG. 8 is a view showing a configuration of the structured document processing program of the second embodiment.

FIG. 9 is a view showing an example of the structured document before a processing operation in the second embodiment.

FIG. 10 is a view showing an example of the structured document formed by a processing operation on the structured document of FIG. 9.

FIG. 11 is a view showing an example of an output of the structured document of FIG. 10.

FIG. 12 is a view showing an example of the structured document formed by a processing operation on the structured document of FIG. 9.

FIG. 13 is a view showing an example of an output of the structured document of FIG. 12.

FIG. 14 is a view showing an example of the structured document formed by a processing operation on the structured document of FIG. 9.

FIG. 15 is a view showing an example of an output of the structured document of FIG. 14.

### DETAILED DESCRIPTION OF THE PREFERRED EMBODIMENTS

The structured document processing device and the structured document processing program of the present invention include a function that forms a structured document including binary data or a link to the binary data, and provides attribute information for designating a processing operation to the binary data in the text data of the structured document. Therefore, a processing operation for the structured document can be designated easily.

Moreover, the structured document processing device and the structured document processing program of the present invention extract attribute information that designates a processing operation for the binary data from the structured document, and process the binary data in accordance with the extracted attribute information. Therefore, the binary data relating to the structured document can be processed automatically.

Moreover, the structured document processing device and the structured document processing program of the present invention extract from the structured document itself, information for determining the type of processing operation for the character-converted binary data included in the structured document, and then processes the binary data. Therefore, the processing operation of the character-converted binary data included in the structured document can be defined by the structured document itself, and the processing operation can be executed automatically.

The processing operation of the character-converted binary data includes output operations such as displaying on a display, printing, forwarding of the file, or saving as a separate file by making a link to the original structured document. By determining these outputting forms in accordance with the information for determining the type of processing operation, a determination for how to output the character-converted binary data can be made automatically.

By extracting information for determining the type of processing operation from the text data, the type of processing operation can be determined by having the original text data as if the text data is a keyword for determining the type of processing operation.

By extracting information for determining the type of processing operation from the data in the text data relating to a communication of when the binary data is received, the type of processing operation can be determined by the information relating to the communication such as a transmitter or a communication unit, a communication path, or a description in a subject section of an electronic mail.

Furthermore, by determining the type of processing operation in accordance with characteristics of the character-converted binary data, the processing operation can be carried out according to the characteristics of the binary data. Further, the characteristics of the character-converted binary data can be a size of the character-converted binary data, a ratio of the character-converted binary data to the entire data relating to the structured document, or a character recognition result of the keyword or the like in the character-converted binary data.

Further, in this specification, unless otherwise noted, the description for the structured document processing device also applies to the structured document processing program. In addition, unless otherwise noted, the description for the structured document processing program also applies to the structured document processing device.

(First Embodiment)

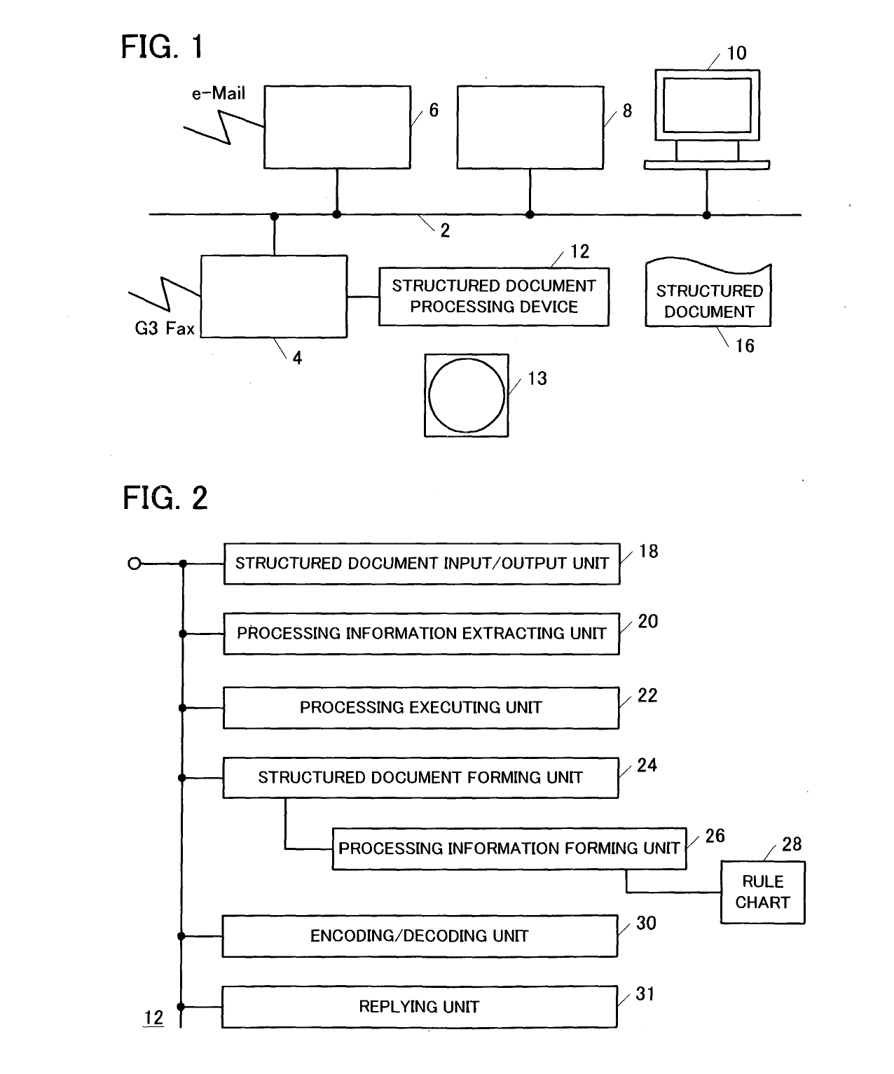

FIG. 1 through FIG. 5 relate to the first embodiment. FIG. 1 shows an environment where the structured document is processed in the first embodiment. Reference number 2 is a Local Area Network (LAN), 4 is a facsimile server, 6 is a mail server, 8 is a document managing server, and 10 is a client terminal.

The facsimile server 4 carries out a transmission and a reception of a G3 facsimile or the like via a public switched telephone network. In addition, the facsimile server 4 carries out a transmission and a reception of an Internet facsimile or the like via the mail server 6. The facsimile server 4 is a multifunction peripheral that includes a printer function, a copy function, an image scanner function or the like. The facsimile server 4 is a server for inputting and outputting image data for the LAN 2.

When receiving facsimile data that includes binary data such as image data, the facsimile server 4 converts the facsimile data into a structured document. At this time, information that designates a processing operation for the binary data included in the structured document is added as attribute information under the text data format. Then, the facsimile data converted into the structured document is forwarded to the document managing server 8, the terminal 10, the mail server 6 or the like. On the contrary, the structured document can be formed by the terminal 10 or the like, and the processing operation for the binary data included in the structured document can be described as the attribute information in the structured document. Then, the structured document can be forwarded to the document managing server 8, the facsimile server 4, the mail server 6 or the like.

Reference number 12 is a structured document processing device. The structured document processing device 12 is equipped in the facsimile server 4, the mail server 6, the document managing server 8, the terminal 10 or the like. Instead of having the structured document processing device 12 in the form of a hardware device, a structured document processing program can be stored in the servers 4 through 8 and the terminal 10 or the like from a recording medium 13 that stores the structured document processing program. That is, the structured document processing device can be equipped in the form of software.

Reference number 16 is a structured document, and the facsimile data received by the facsimile server 4 is structured. Moreover, the structured document 16 can include binary data such as image data formed by the terminal 10 or the like. A processing operation for the binary data is described in the structured document 16 as attribute information. Further, a character-conversion or the like can be executed on the binary data, and character-converted binary data can be embedded in the structured document 16. Alternatively, binary data can be created as a separate file, and a link to the binary file can be created in the structured document 16.

FIG. 2 shows a configuration of the structured document processing device 12. Reference number 18 is a structured document input/output unit. An existing resource in the facsimile server 4 or the like can be used for the structured document input/output unit 18. Reference number 20 is a processing information extracting unit. The processing information extracting unit 20 extracts information describing the processing operation for binary data from the text data included in the structured document. The processing operation includes displaying on a display, printing, saving, forwarding, converting, or replying (notifying) after the processing operation has been completed. For example, these specific contents are described in the structured document as processing information.

In the case the processing operation is displaying, a type of display can be designated as the processing information. For example, the type of display can include embed (inline) displaying in the structured document or the like, displaying in a separate window, or displaying in a thumbnail. In the case the processing operation is printing, embed (inline) printing or printing to a separate paper, a size or a format of the paper to be used in printing, and other printing conditions can be designated as the processing information. In the case the processing operation is saving, whether to save as a separate file or whether to save as the structured document directly, the file name or a place to save, or a file format to be used for saving can be designated as the processing information.

In the case the processing operation is forwarding, a destination, a communication channel to be used for forwarding (for example, whether it is a forwarding within the LAN, G3 facsimile, or Internet facsimile), a time when the communication is carried out, and information (header, cover page or the like) to be added at the time of the communication can be designated as the processing information.

In the case the processing operation is converting, a resolution conversion, an encoding method, a color conversion, a size conversion of enlarging/reducing and the content of the size conversion can be designated as the processing information.

These processing operation can be described individually or in a plurality.

Reference number 22 is a processing executing unit. The processing executing unit 22 processes the binary data in accordance with the extracted processing information. The content of the processing operation are as described above. The content can be displayed in the following ways. The image data can be embedded in the text data or the like, and displayed. The text data and the image data can be displayed in separate windows. The image data can be displayed in a thumbnail.

In the case of outputting by printing, for example, embed (inline) printing, or printing of the text data and the image data on separate papers can be carried out. The paper to be used for printing, the print format or the like can be designated.

Furthermore, in the case of saving the image data, the file format or a place to save, the file name or the like are determined in accordance with the processing information. Moreover, in the case of forwarding at least the image data, and preferably the entire structured document from the facsimile server 4 to the document managing server 8 or the like, the forwarding is executed in accordance with the processing information extracted by the processing information extracting unit. Further, the processing information extracted by the processing information extracting unit includes an address of the destination, a communication unit to be used for forwarding, and the communication time when the forwarding is executed or the communication information to be added at the time of forwarding.

Furthermore, in the case of the file conversion, in accordance with the processing information extracted by the processing information extracting unit 20, the resolution of the image data is converted, the encoding method is converted, the color size is converted, or the size conversion of enlarging/reducing is executed. Moreover, a plurality of processing operations can be designated and executed on the image data, such as displaying, printing, forwarding, and converting.

A structured document forming unit 24 forms the structured document embedded with the processing information. A processing information forming unit 26 forms the processing information that is to be embedded in the text data of the structured document as the attribute information. In the case of automating the formation of the processing information, a rule chart 28 or the like is used. For example, the rule chart 28 can store an attribute value or keyword of the structured document, or data for converting the characteristics of the binary data into the processing information.

In the case of handling the binary data such as image data, it is preferable to carry out a binary-character conversion, and to embed the binary data in the structured document as the character data. On the contrary, in the case of extracting the character-converted binary data from the structured document and processing operation of the character-converted binary data, it is necessary to carry out the character-binary conversion. An encoding/decoding unit 30 encodes the binary data (binary-character conversion), and decodes the character-converted binary data (character-binary conversion).

Reference number 31 is a replying unit. The replying unit 31 returns the processing operation result to the transmitter or the like when executing the processing operation such as displaying, printing, forwarding, saving, and converting to the structured document. The replying is not carried out generally. That is, the replying can be carried out when the processing information extracted by the processing information extracting unit 20 includes a description that a return mail is necessary or that a return mail should be returned in the case of failure in the processing operation.

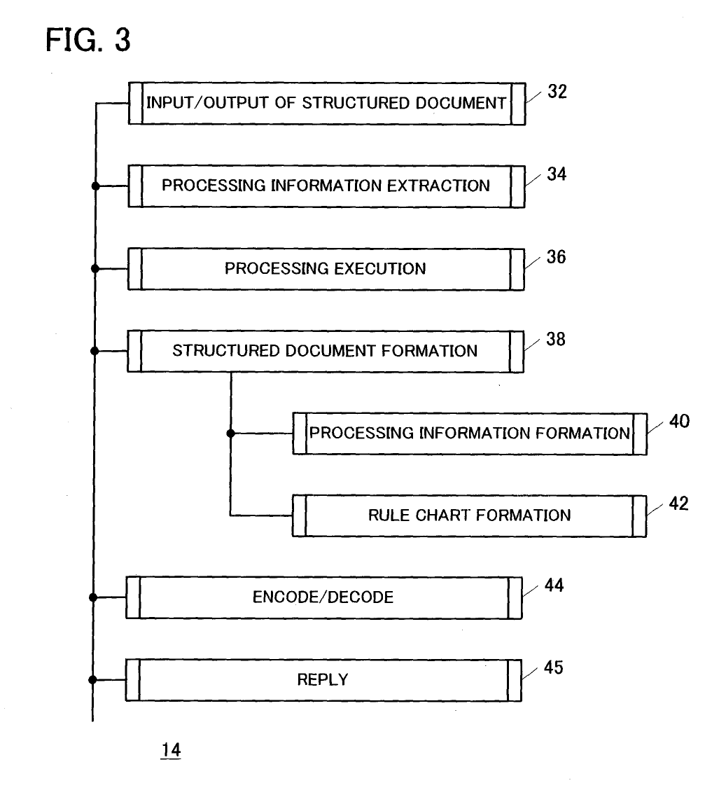

FIG. 3 shows a structure of the structured document processing program 14. Each part of the structured document processing program 14 is similar to each component of the structured document processing device 12. The description for the structured document processing device 12 also corresponds to the structured document processing program 14 unless otherwise noted.

Reference number 32 is an input/output subroutine of the structured document. An existing element in the facsimile server 4 or the like can be used for the input/output subroutine 32. Reference number 34 is a processing information extraction subroutine, and extracts information of a type or content of the processing operation from the text data of the structured document.

For the types of processing operation, there are displaying, printing, saving, forwarding, converting, replying or the like. In the case the type of processing operation is displaying or printing, a designation can be made for, for example, whether or not to carry out an embed (inline) displaying or an embed (inline) printing, whether to print on a separate window or on a separate paper, whether to display in a thumbnail or the like, or the size or the format of the paper to be used for printing.

In the case the type of processing operation is saving, for example, the file name or a place to save, the format of the file to be saved can be designated as the processing information. In the case the type of processing operation is forwarding, for example, the address of the destination, the communication unit to be used for forwarding, the communication time, or the information to be added at the time of forwarding can be designated as the processing information.

In the case the type of processing operation is converting, for example, the resolution after the conversion in the case of image data, the encoding method, the color conversion, or the size conversion can be designated as the processing information. In the case the type of processing operation is replying, under what kind of condition the processing operation result will be returned to the transmitter can be described as the processing information. The processing execution subroutine 36 processes the binary data included in the structured document, for example, the image data, in accordance with the extracted processing information.

A structured document formation subroutine 38 forms the processing information for the binary data included in the structured document by using a processing information formation subroutine 40. In the case of automating the formation of the processing information, the processing information is formed based on the keyword or the characteristics of the binary data included in the structured document. For example, a rule chart stores rules for converting the keyword or the characteristics of the binary data into the processing information. Reference number 42 is a rule chart formation subroutine. The rule chart formation subroutine 42 is used for the formation of the rule chart that defines what kind of processing will be requested if there is what kind of keyword or what kind of characteristics included in the binary data.

The structured document of the first embodiment handles the binary data such as image data. Therefore, it is necessary to convert the binary data into character data, or on the contrary to restore the character-converted binary data included in the structured document into original binary data. An encode/decode subroutine 44 carries out such encoding (binary-character conversion) and decoding (character-binary conversion). A reply subroutine 45 returns the processing result when the reply is requested under a prescribed condition by the processing information.

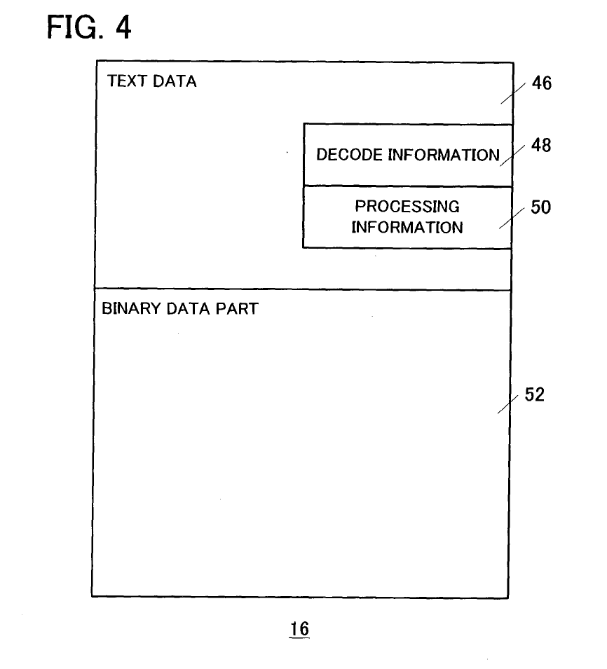

FIG. 4 shows the structure of the structured document 16. Decode information 48 and processing information 50 are embedded in the text data part 46 as the attribute information respectively. In the processing device or the processing program for the structured document, the processing information 50 is extracted, the processing operation is determined, and by using the decode information 48, the character-converted binary data is decoded into the original binary data. Reference number 52 is a binary data part in the structured document. The image data is character-converted in the binary data part 52.

In FIG. 4, the character-converted binary data is embedded in the structured document. Moreover, the binary data can be made as a separate file and a link to the binary data can be made in the structured document. Then, the processing operation for the linked binary data can be described in the text data part of the structured document.

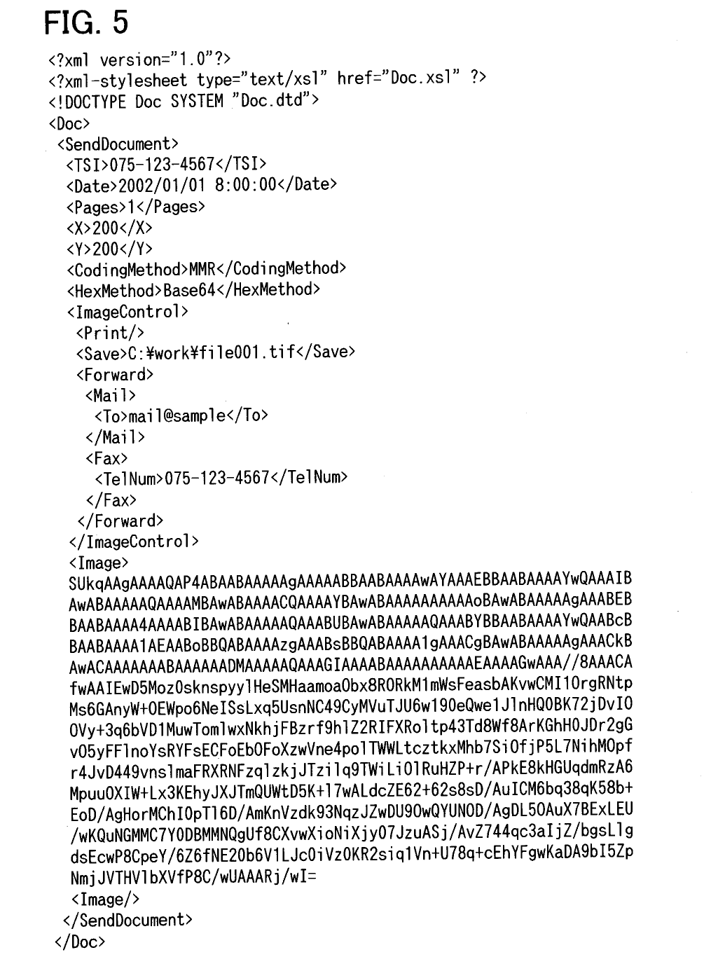

FIG. 5 shows an example of the structured document. As an example of the processing operation for the structured document, an electronic mail transmission, a facsimile transmission, printing, and saving of the structured document are designated. It is designated to save the structured document under a tif format as “file001” in a directory “work”. In addition, it is designated to print the binary data part that is converted into image data from character data. Moreover, an e-mail and a facsimile are designated for forwarding, and the e-mail address and the facsimile number are designated.

The image data is encoded by “Modified Modified Read (MMR)”, and character-converted by “Base 64”. Therefore, the decode information designates that the image data is encoded by the MMR and character-converted by the Base 64. In addition, the character-converted image data is described in the part of the attribute “Image”.

In the first embodiment, a processing operation for the binary data can be described in the structured document. Therefore, the structured document that determines the processing operation for the binary data can be formed, and the handling of the binary data becomes easy. In particular, the processing operation for the binary data can be defined in the structured document, and the binary data can be processed automatically. Further, in the first embodiment, the formation of the structured document having the processing information as the attribute is included in the processing device or the processing program for the structured document. However, a device or a program can just execute the processing operation of the structured document having the processing information as the attribute. Moreover, the binary data is not limited to the image data.

(Second Embodiment)

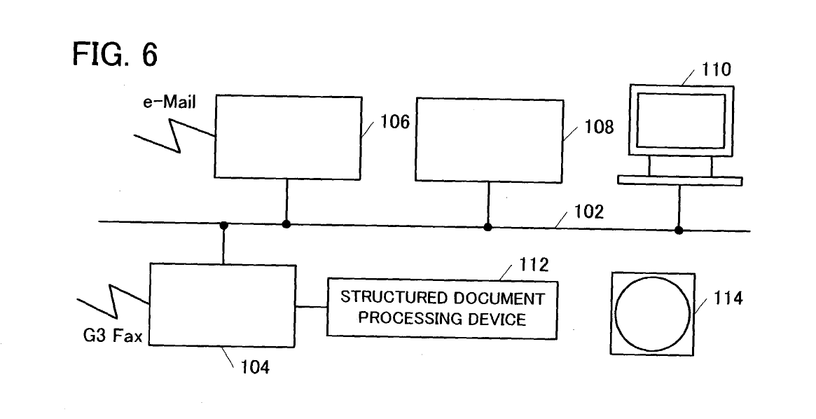

FIG. 6 through FIG. 15 show the second embodiment. FIG. 6 shows an environment where a structured document processing device 112 of the second embodiment is used. Reference number 102 is a LAN, 104 is a facsimile server, 106 is a mail server, 108 is a document managing server, and 110 is a client terminal.

The facsimile server 104 carries out a transmission and a reception of a G3 facsimile or the like via a public switched telephone network. In addition, the facsimile server 104 carries out a transmission and a reception of an Internet facsimile via the mail server 106 or the like. Moreover, the facsimile server 104 is a multifunction peripheral having a facsimile function, a printer function, a copy function, an image scanner function or the like. The facsimile server 104 is also a server for carrying out input/output of an image for the LAN 102.

The structured document processing device 112 of the second embodiment is included in the facsimile server 104 as an example. However, the structured document processing device 112 can be included in the mail server 106, the document managing server 108, the client terminal 110 or the like. Moreover, in place of including hardware for the structured document processing device 112 in the facsimile server 104 or the like, by using a recording medium 114 that is recorded with a processing program of the structured document, a processing program can be stored in the facsimile server 104, the document managing server 108, the terminal 110 or the like.

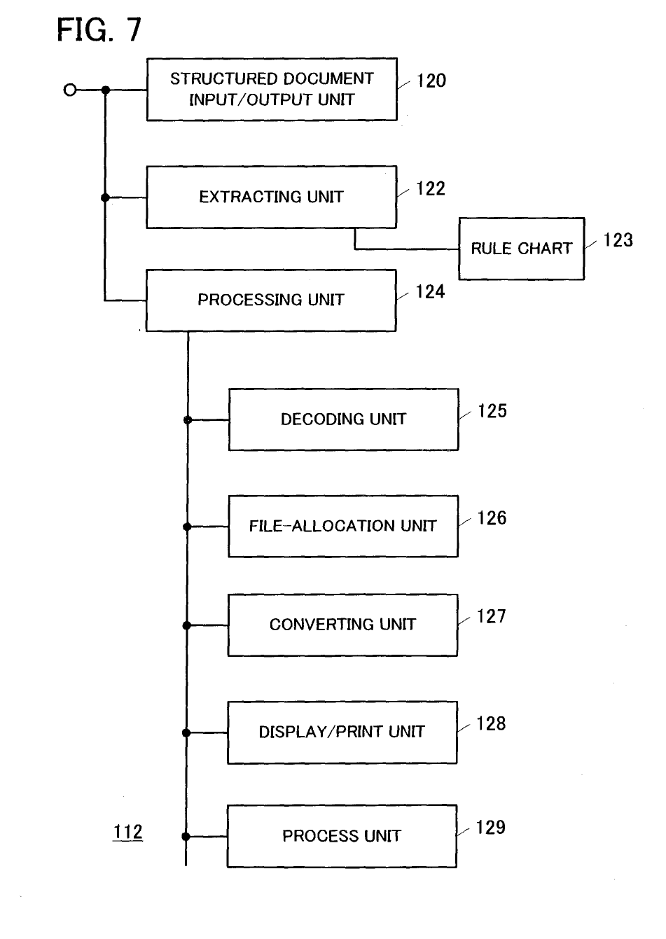

FIG. 7 shows a configuration of the structured document processing device 112. Reference number 120 is a structured document input/output unit. An existing unit in the facsimile server 104 or the like can be used for the structured document input/output unit 120. Reference number 122 is an extracting unit. The extracting unit 122 extracts information for determining the type of processing operation to be executed to the character-converted binary data from the structured document itself. In the second embodiment, the binary data is the image data routed through the facsimile server 104 or the like. In addition, the binary data is character-converted and embedded in the structured document. The binary data can be in other forms such as voice data.

The extracting unit 122 extracts the characteristics of the structured document itself, for example, the keyword that is included in the original text data. In particular, the extracting unit 122 extracts an e-mail address or a telephone number of a transmitter or a name of the transmitter of the facsimile communication, a name of the destination, the writing in the subject column or the like as the keyword. Such keyword is extracted from the data relating to the communication of when receiving the image data (at this point, the binary data in principle) by electronic mail, the G3 facsimile or the like. Moreover, the extracting unit 122 determines the type of processing operation by the keyword such as “urgent” that can be obtained when recognizing the image data. Furthermore, the extracting unit 122 can determine the type of processing operation by the size of the character-converted image data or by a percentage of the image data in the entire data of the structured document.

Reference number 123 is a rule chart. The rule chart 123 stores the rule for determining the type of processing operation in accordance with a number of the transmitter or an e-mail address of the transmitter of the facsimile communication, the name of the transmitter, the keyword in the subject or the like in the header part, the keyword of when recognizing the image data as the character, or the size or the ratio of the image data.

A processing unit 124 executes the processing operation of the type determined by the extracting unit 122 to the character-converted binary data. The binary data is stored in the structured document after being converted into character data. Therefore, a decoding unit 125 is provided for decoding the character data into the original binary data.

The general types of processing operations include:

decoding the character-converted image data into the original image data, and displaying the image data on a display,

decoding the character-converted image data into the original image data, and printing out the image data from a printer,

forwarding the file,

decoding into image data, saving as a separate file, describing the link name or the file path, and making a link.

A file-allocation unit 126 saves the decoded image data as a separate file. In addition, the file-allocation unit 126 embeds the link name or the file path for the separate file in the original structured document. Further, embedding of the link name or embedding the file path will be simply referred to as “to link”.

In the processing operation of the image data, there are many cases when a conversion is executed. The conversion can be a conversion of the image data into a file format that can be displayed by a browser such as Joint Photographic Experts Group (JPEG), Portable Network Graphics (PNG), or Graphics Interchange Format (GIF), a conversion of reducing/enlarging of the data, or a color conversion. These conversions are executed before an output operation such as displaying or printing of the binary data such as the image data. Moreover, the JPG, the PNG, and the GIF are types of formats for the image data respectively.

A converting unit 127 executes a conversion, such as a conversion of the file format, reducing/enlarging, or a color conversion to the binary data.

In the case the type of processing operation is displaying the image data included in the structured document on a display, a display/print unit 128 displays the structured document or the image data part on the display. In the case the type of processing operation is printing, the display/print unit 128 prints the structured document or the image data part. In the case of displaying the structured document on the display, it is preferable to display the original text part, and the other part that is character-converted from the binary data in separate windows.

A process unit 129 executes other processing operations to the binary data. For example, the process unit 129 executes a character recognition, and executes a processing operation to transfer the recognized character into the original text part under the attribute of <message>or the like.

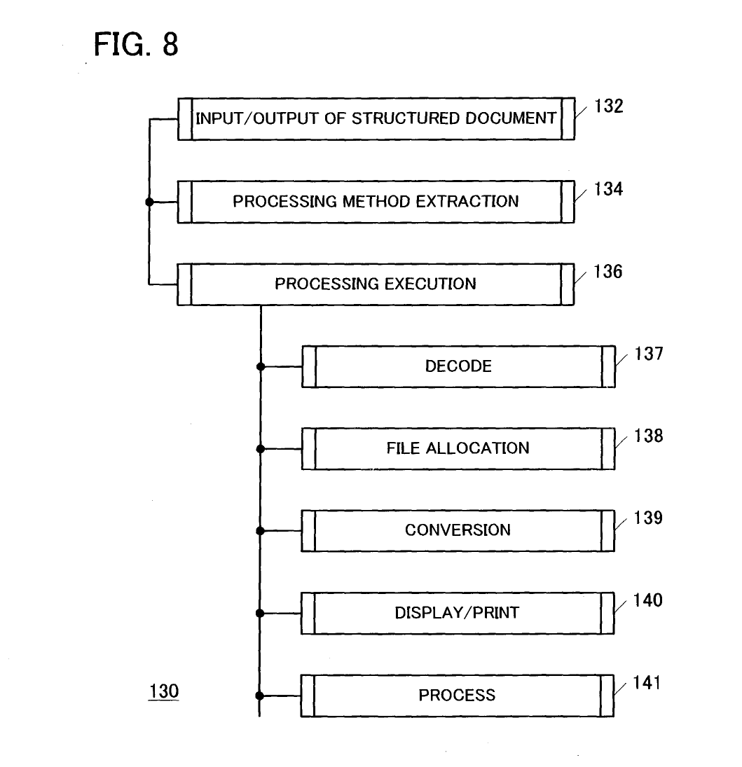

FIG. 8 shows a structure of a structured document processing program 130. As shown in FIG. 6, the structured document processing program 130 is stored in an appropriate storage unit 114 or the like. Alternatively, the structured document processing program 130 is forwarded to the facsimile server 104 or the like via the communication line or the like.

In FIG. 8, reference number 132 is an input/output subroutine of the structured document. An existing resource in the facsimile server 104 or the like can be used for the input/output subroutine 132.

Reference number 134 is a processing method extraction subroutine. The extraction subroutine 134 determines the type of processing operation from the structured document itself for the image data included in the structured document. The method for determining the processing operation is the same as the method described for the extracting unit 122 of FIG. 7.

Reference number 136 is a processing execution subroutine. The processing execution subroutine 136 includes a decode subroutine 137, a file-allocation subroutine 138, a conversion subroutine 139, a display/print subroutine 140, and a process subroutine 141.

The contents of the processing operation of the processing execution subroutine 136, and the associated decode subroutine 137 through the process subroutine 141 are the same as the contents described for the processing unit 124 through the process unit 129 of FIG. 7.

The decode subroutine 137 converts the image data converted into the character data into the original binary data. The file-allocation subroutine 138 saves the binary-converted image data as a separate file. In addition, the file-allocation subroutine 138 embeds the link information such as the link name or the file password in the structured document. The conversion subroutine 139 converts the format of the file, and executes a conversion of reducing/enlarging, a color conversion or the like.

The display/print subroutine 140 executes an output operation such as displaying or printing of the file. The process subroutine 141 executes a character recognition or the like to the binary-converted image data. As described above, the description for the structured document processing device 112 can be applied directly to the structured document processing program 130.

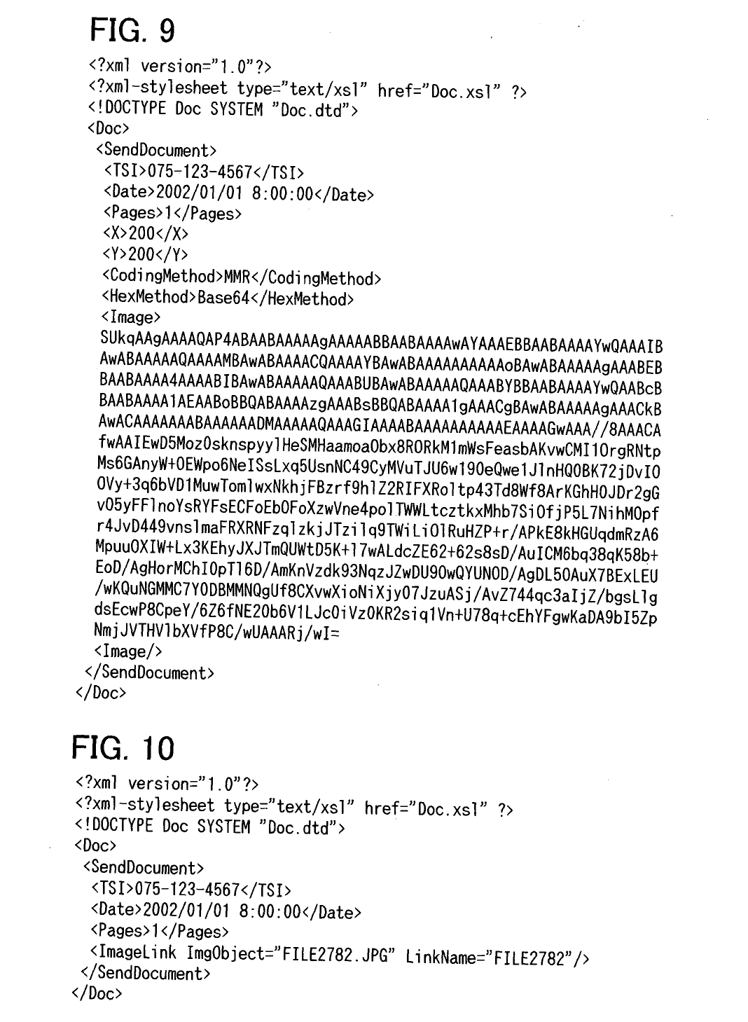

FIG. 9 through FIG. 15 show an example of the structured document and how the structured document is displayed. FIG. 9 shows the structured document before being processed by the processing unit. For example, the image data received by the G3 facsimile is coded by the MMR, the coded image data is character-converted by the Base 64, and the character-converted image data is described in the structured document. Moreover, the telephone number of the transmitter (Transmitting Subscriber Identification (TSI)), the date and time of the reception, a number of pages, a starting position of the facsimile data or the like are described as the original text data. These data are handled as the keyword, and the type of processing operation is determined.

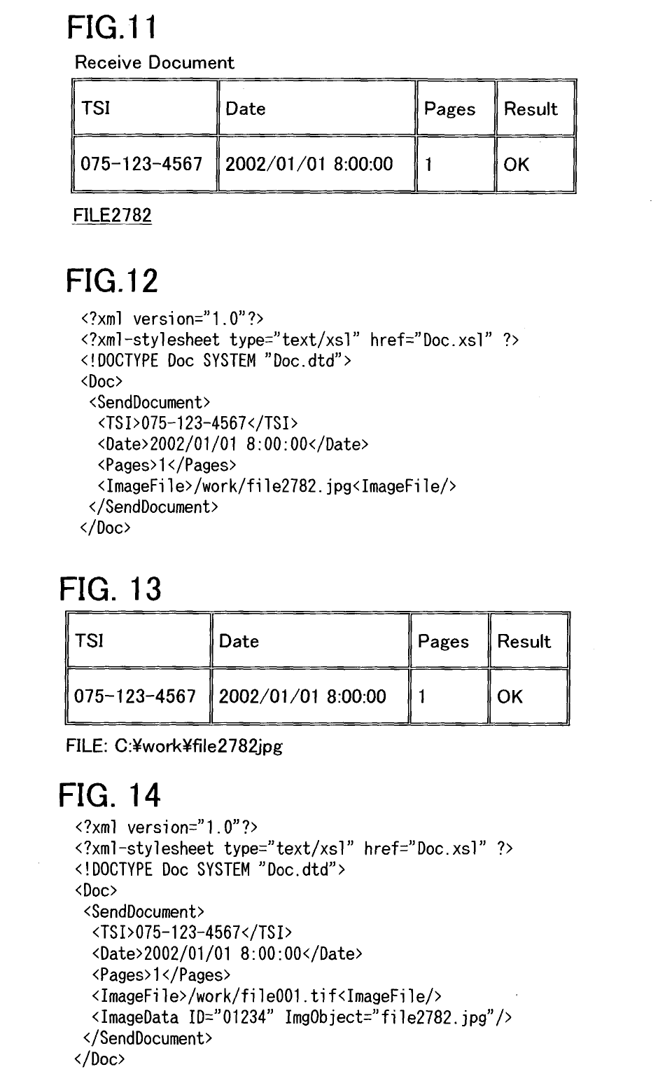

FIG. 10 shows an example of the structured document that is formed by binary-converting the character-converted image data included in the structured document of FIG. 9, converting the format into the JPG file, and making a link as “FILE2782.JPG”. Although it is not described in the structured document of FIG. 10, a processing operation to display a fact of the reception of the facsimile data on a prescribed terminal can be added as the processing operation. For example, FIG. 11 shows an example of displaying the information relating to the communication (TSI, reception date and time, and number of pages) and link information in the structured document of FIG. 10.

In the structured document of FIG. 10, by designating the link name, the file of the image data is linked. However, by designating a file path or the like, the file of the image data can be linked. Such an example is shown in FIG. 12 and FIG. 13. To convert the binary data into “file2782.jpg” and to store in the directory “work” are designated as the file path. When displaying the reception of the facsimile data on the designated terminal, for example, a display as shown in FIG. 13 is displayed.

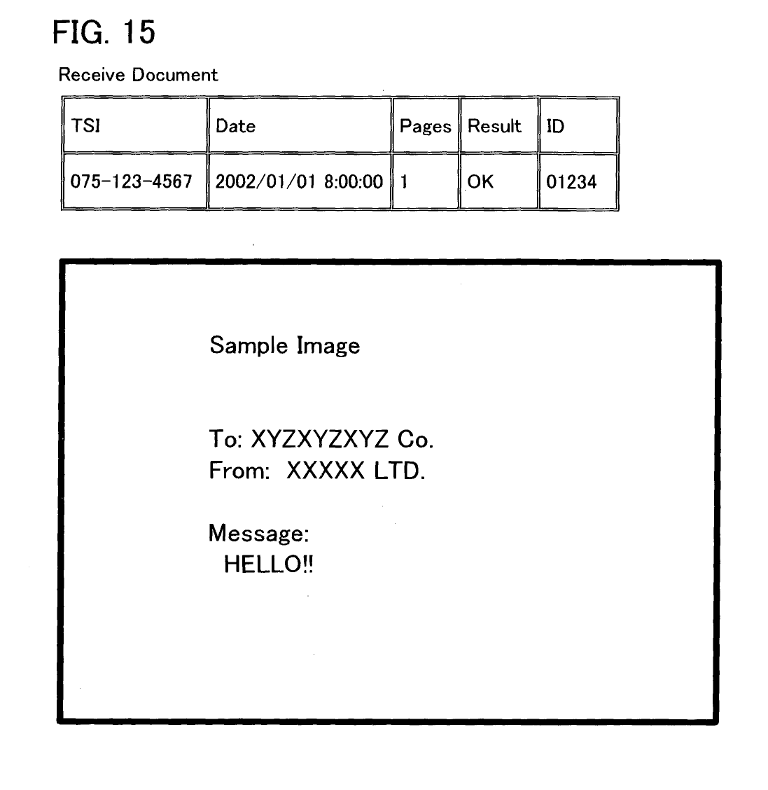

FIG. 14 shows an example of the structured document that describes how to execute the following processing operation. That is, to decode the character-converted image data included in the structured document, to convert the format into a file of Joint Photographic Experts Group (JPEG) format, to embed the file path in the structured document, and to display on the display or to output to the printer the image file of “file2782jpg”. FIG. 15 shows an example of the display corresponding to FIG. 14. The display of FIG. 15 is displayed on a prescribed client terminal or the like. The information relating to the communication (for example, the TSI or the reception date and time, the number of pages, a fact of reception, an ID of the facsimile reception, or a description in the header part in the case of the Internet facsimile) and the received image data itself are displayed.

In the second embodiment, the structured document is formed by the facsimile server 104 or the like, and transmitted to the document managing server 108, the terminal 110 or the like. However, the structured document can be formed by the terminal 110 or the document managing server 108, the type of processing operation can be determined and executed by the facsimile server 104 or the like.

In the second embodiment, by using the data itself included in the structured document, the type of processing operation for the character-converted binary data included in the structured document is determined and executed. Therefore, by using the structured document itself, the type of processing operation, such as displaying, printing, file forwarding, or decoding into the binary data, making as a separate file, linking and saving, can be determined and executed automatically.

What is claimed is:

1. A structured document processing device comprising:
a structured document forming unit which forms a structured document including binary data or a link to the binary data; and
a processing information forming unit which forms text data in the structured document, wherein the text data indicates attribute information that designates a processing operation for the binary data.

2. The structured document processing device according to claim 1, wherein the processing operation is displaying, and the attribute information includes information relating to the displaying operation.

3. The structured document processing device according to claim 1, wherein the processing operation is printing, and the attribute information includes information relating to the printing operation.

4. The structured document processing device according to claim 1, wherein the processing operation is saving, and the attribute information includes information relating to the saving operation.

5. The structured document processing device according to claim 1, wherein the processing operation is forwarding, and the attribute information includes information relating to the forwarding operation.

6. The structured document processing device according to claim 1, wherein the processing operation is converting, and the attribute information includes information relating to the converting operation.

7. A structured document processing device comprising:
a structured document input unit which inputs a structured document including binary data or a link to the binary data, and text data showing attribute information that designates a processing operation for the binary data;
a processing information extracting unit which extracts the attribute information designating the processing operation for the binary data included in the structured document; and
a processing execution unit which executes the designated processing operation in accordance with the attribute information.

8. The structured document processing device according to claim 7, further comprising a processing result reply unit which supplies a processing result after the processing operation is completed.

9. A structured document processing device comprising:
a structured document input unit which inputs a structured document including text data and character-converted binary data;
a processing information extracting unit which extracts information from the structured document for determining a processing operation for the character-converted binary data, and determines a type of processing operation; and
a processing execution unit which executes the determined type of processing operation.

10. The structured document processing device according to claim 9, wherein the processing operation is to output the character-converted binary data, and a type of output for the binary data is determined as the type of processing operation.

11. The structured document processing device according to claim 9, wherein the processing information extracting unit extracts the information for determining the type of processing operation from the text data.

12. The structured document processing device according to claim 9, wherein the structured document is formed by character-converting the received binary data, the data relating to the communication obtained at the reception is included in the text data, and the processing information extracting unit determines the type of processing operation from the data relating to the communication included in the text data.

13. The structured document processing device according to claim 9, wherein the processing information extracting unit determines a type of processing operation in accordance with characteristics of the character-converted binary data included in the structured document.

14. The structured document processing device according to claim 9, wherein the determined type of processing operation is to output the binary data as a file and to describe a link information to the file in the structured document.

15. A recording medium recording a program for processing a structured document, comprising:
a command for forming a structured document which includes binary data or a link to the binary data; and
a command for forming a text data showing attribute information that designates a processing operation for the binary data in the structured document.

16. A recording medium recording a program for processing a structured document, comprising:
a command for inputting a structured document which includes binary data or a link to the binary data, and text data showing attribute information that designates a processing operation for the binary data;
a command for extracting the attribute information that designates a processing operation for the binary data included in the structured document; and
a command for executing the designated processing in accordance with the attribute information.

17. A recording medium recording a program for processing a structured document, comprising:
a command for inputting a structured document that includes text data and character-converted binary data;
a command for extracting information for determining a processing operation for the character-converted binary data from the structured document, and for determining a type of processing operation; and
a command for executing the determined type of processing operation.

18. A structured document processing device comprising:
means for forming a structured document including binary data or a link to binary data; and
means for forming text data in the structured document, wherein the text data indicates attribute information that designates a processing operation of the binary data.

19. The structured document processing device according to claim 18, wherein the processing operation is displaying, and the attribute information includes information relating to the displaying operation.

20. The structured document processing device according to claim 18, wherein the processing operation is printing, and the attribute information includes information relating to the printing operation.
